(19) United States
(12) Patent Application Publication
(10) Pub. No.: US 2011/0169972 A1
(43) Pub. Date: Jul. 14, 2011

(54) Steadycam

(76) Inventor: Vicente Maldonado, Bridgeport, CT (US)

(21) Appl. No.: 12/686,309

(22) Filed: Jan. 12, 2010

(51) Int. Cl. H04N 5/228

(52) U.S. Cl. 348/208.7; 348/E05.031

(57) ABSTRACT

Is a camera stabilizer design based on pendulum system, in where the camera hangs in the lower extremity of the pendulum and the counterbalances are situated in the upper position of the center pendulum centered, the system of the pendulum is adjoined to the support arm by a universal union point, it has two gearmotors for palm and tilt function controls.

### FIELD OF THE INVENTION

With current problems to stabilize the image in video shots while is in movement. A cameraman that has to walk, run and then raises or lowers camera to follow image being filmed. He must follow the objectives while avoiding obstacles in his path or around him.

This invention is designed to absorb the movement of balances not wished. From video camera movements while filming to support and improve the quality of the shots. Also this equipment has two motors that are manually controlling the movements for pan and tilt, helping this way to easily focus the point wished for the shooting, it is possible to be adapted to most of video cameras.

### BACKGROUND OF THE INVENTION

The stabilizers of balance and oscillation of cameras are mechanisms that are at first based of a point balance which this hangs to an arm. In one extreme of the roll axis is the camera, and in the other the counterbalances. Commonly they are known like STEADYCAMS. Some have been published in the registry of patents of the USA by No ref: 2007215; 4474439; 5243370; 5742859; 5963749; 6149112; 7390131. All these mechanisms serve to isolate to the camera of the movement no wished of the camera man, but they have problems, or in montage of the camera; in the fast assembled of the mechanism; in extra weight; in the size of the apparatus; in the lack of manual control of movement; or in the reach that can be obtained, being thus:
1. The need exists to build an apparatus that helps to solve the stability problem taking into account the complicated thing which they can be the uncontrolled movements generated by a camera man.
2. The need of built an apparatus for control the movement manually of the camera, for pan an tilt sense.
3. The need exists to create an apparatus in order to reach heights or distances using one extension.

### SUMMARY OF PREFERRED EMBODIMENTS

This invention this based on the principle of the pendulum, in where the video camera hangs in a mechanism connected in an end of the pendulum, while to the other end of the balance center are equipped horizontal axes with counterbalances located in the ends of the axes, also it is possible to be inverted easily putting it offset them of pendulum and the camera in the superior part.

The balance center this mounted on a drum of bearings to help the horizontal movement, this drum of bearings this connected by a system of cross to the support arm that handles the camera man.

### BRIEF DESCRIPTION OF THE DRAWINGS

In order to do compressive the components has been used 6 figures with the numbered parts for explain the mechanism.

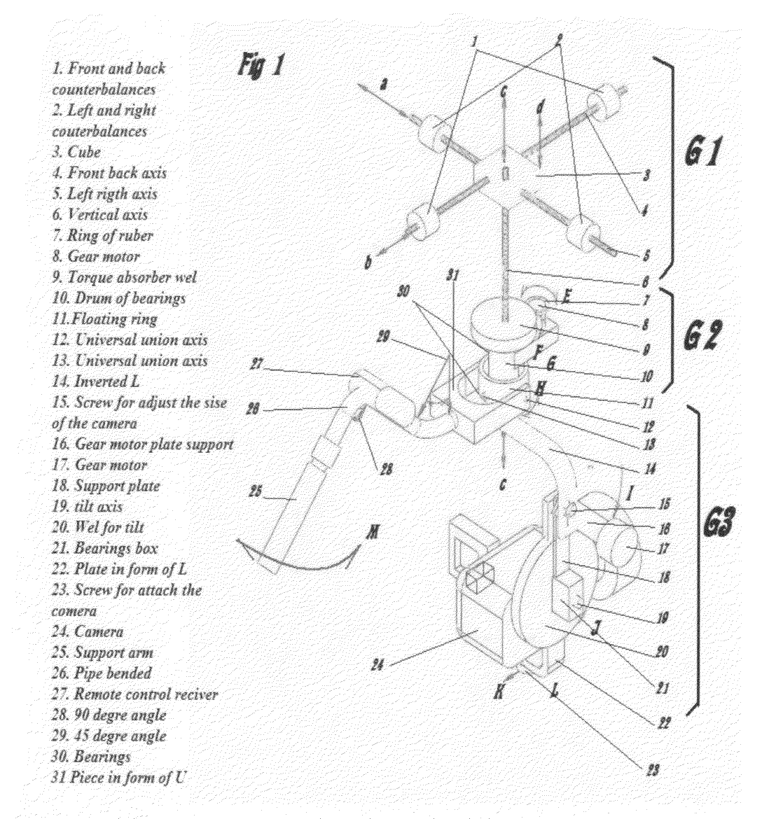

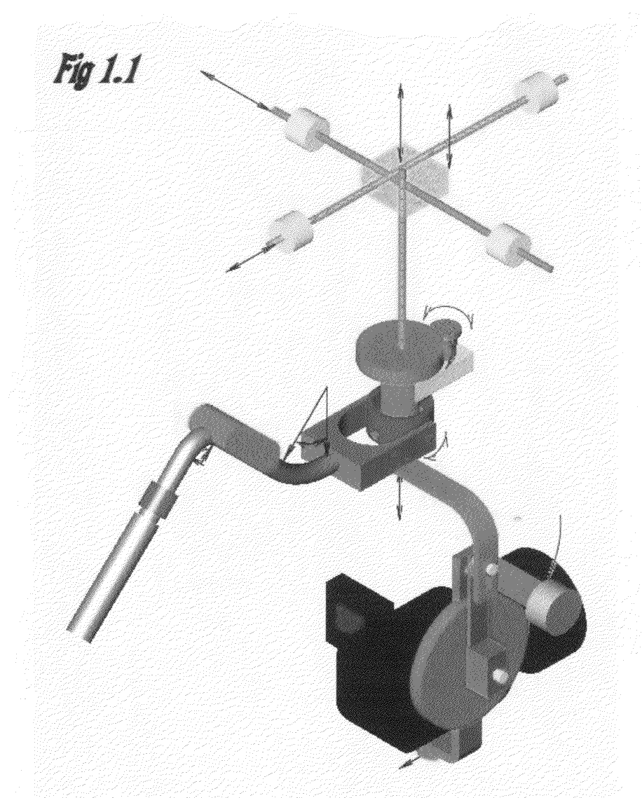

1. The FIG. 1 show numbered of the parts from an isometric perspective.

2. The FIG. 1.1 shows the isometric perspective in colors.

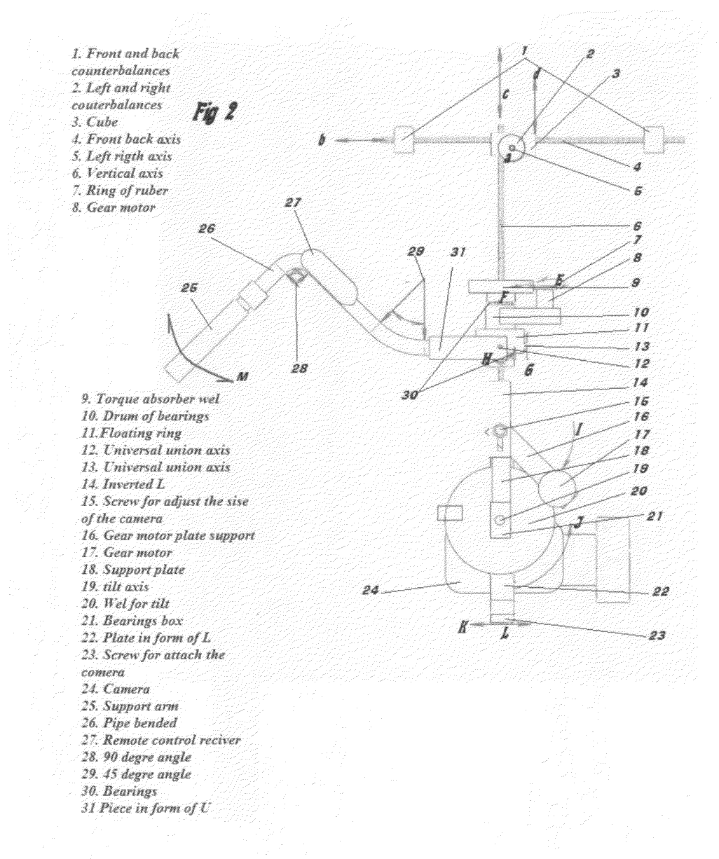

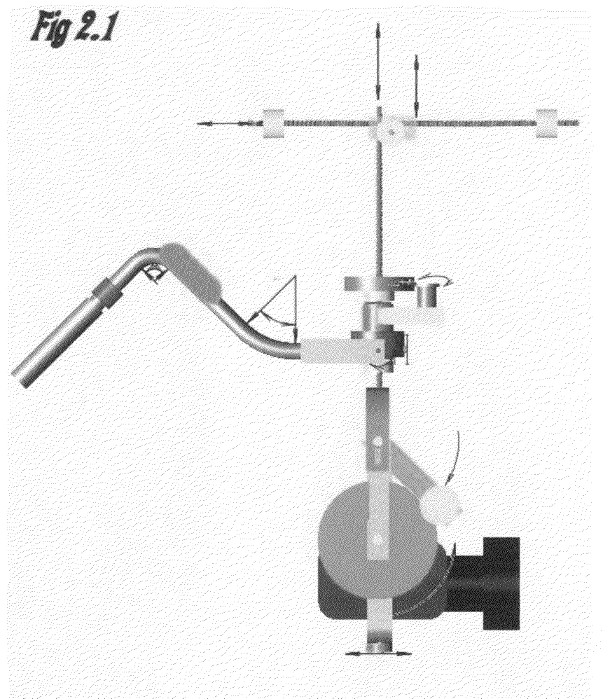

3. The FIG. 2 shows the number of the parts to us from the right point of view of the apparatus.

4. The FIG. 2.1 shows the right point of view in colors.

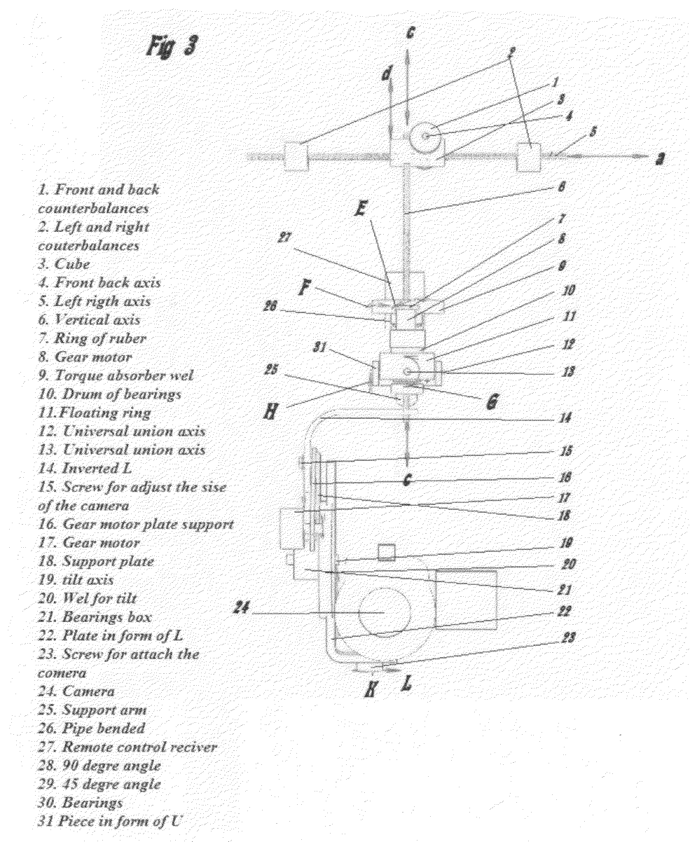

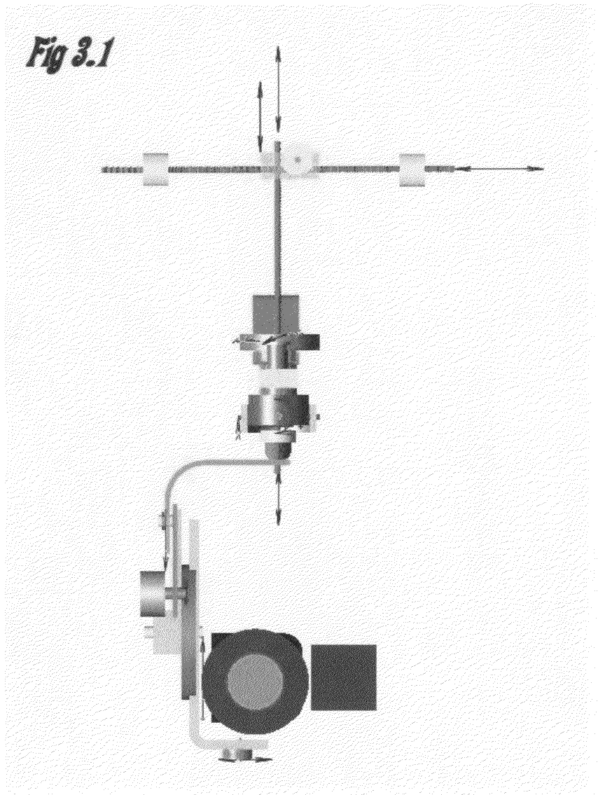

5. The FIG. 3 shows the numbered of parts from the point of view of the front of the apparatus.

6. The FIG. 3.1 shows the point of view of the front in colors.

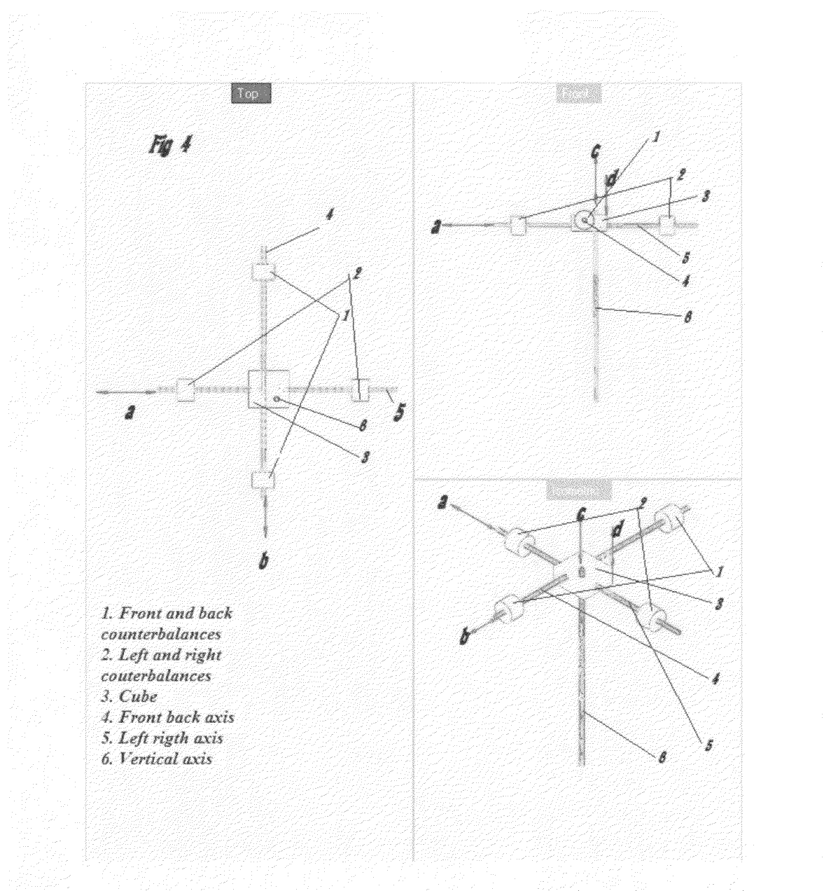

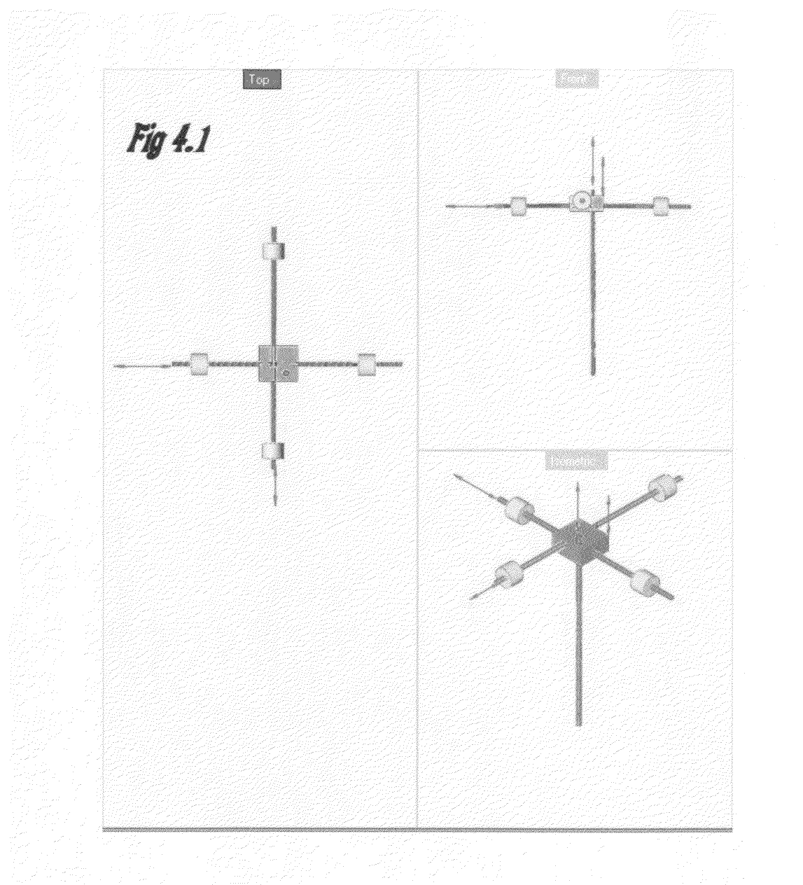

7. The FIG. 4 shows the numbered parts from the point of view of: from the top; from the front; and from the isometric perspective of the balance system. The apparatus.

8. The FIG. 4.1 shows the point of view: from the top; from the front; and from the isometric perspective of the balance system. The apparatus in colors.

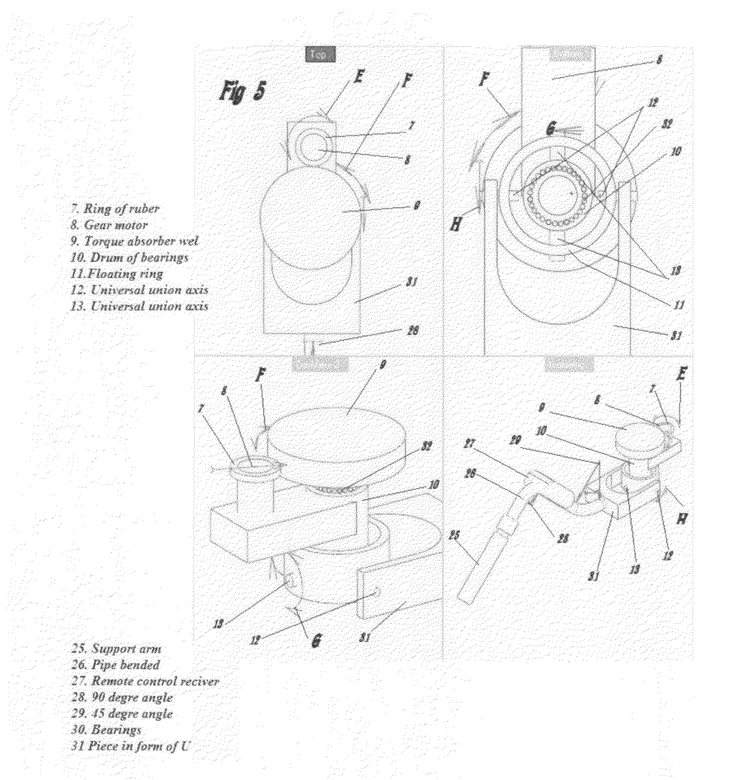

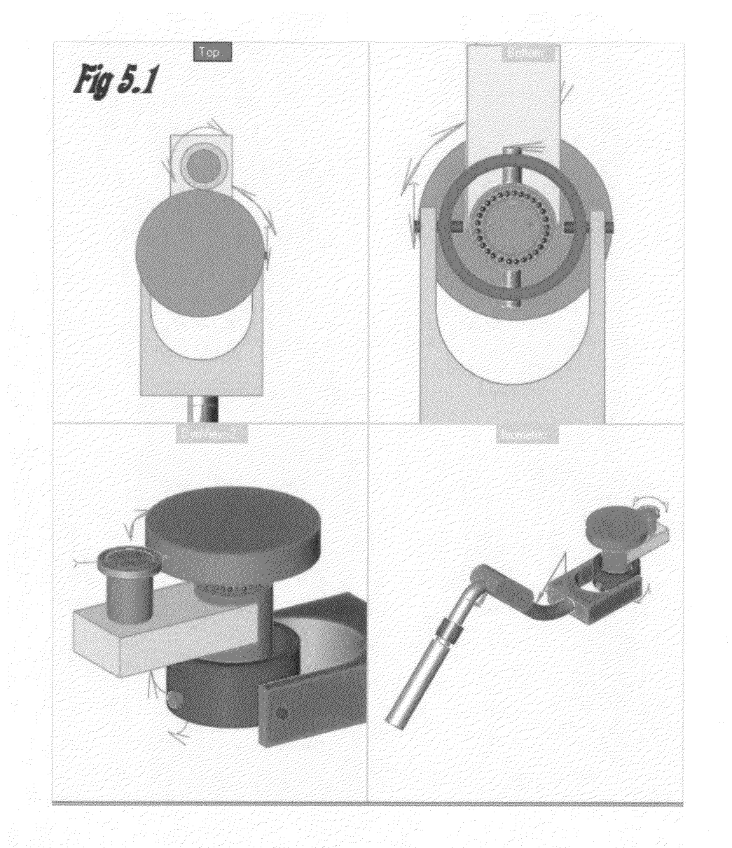

9. The FIG. 5 shows the numbered parts from the point of view of: from the top; from the bottom; from a perspective that shows the bearing system; and from an isometric perspective of the center of the system of balance of the apparatus.

10. The FIG. 5.1 shows: from the point of view of: from the top; from the bottom; from a perspective that shows the bearing system; and from an isometric perspective of the center of the system of balance of the apparatus in colors.

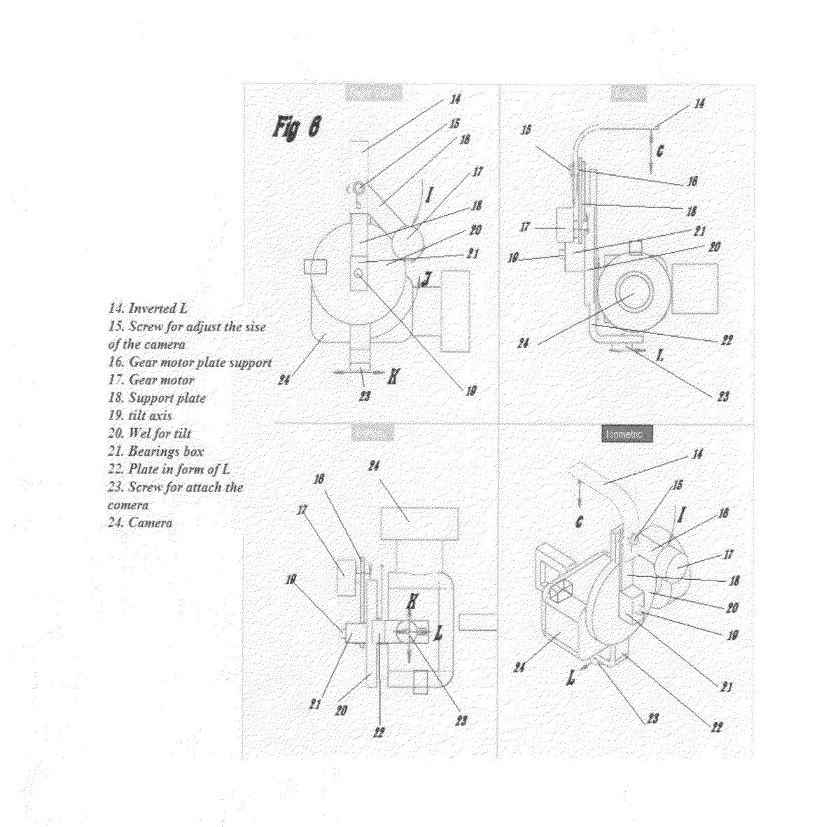

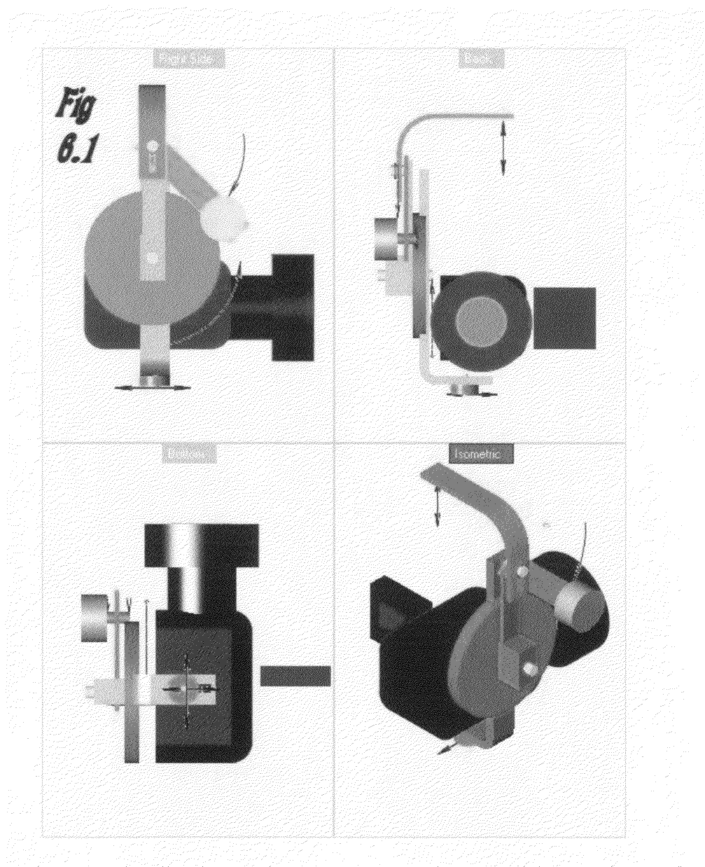

11. The FIG. 6 shows the numbered parts from the point of view of: the right side; from the front; from the bottom; and a perspective isometric of assembly of the camera of the apparatus.

12. The FIG. 6.1 shows the point of view of: the right side; from the front; from the bottom; and a perspective isometric of assembly of the camera of the apparatus.

### DETAILED DESCRIPTION OF THE PREFERRED EMBODIMENTS

1. This stabilizing mechanism is built with three main groups (named—G1—; G2; and G3 in the figures #1) in where: G1 is the mechanism of counterbalances of the apparatus; G2 is the mechanism of the balance center and support of the apparatus; and G3 it is the mechanism of pendulum and support of the camera.

2. The counterbalances that are 4 (named: 1 and 2 in the figures: #1; #2; #3; and #4) they are screwed to two axes with (named: 4; and 5 in the figures: #1; # 2; #3; and #4) that helps of way by side to side to look for the level center screwing of the side axis side (named with the arrows: a; and b as show in the figures: #1; #2; #3; and #4), is two counterbalances by each axis, each axis is a screw.

3. The axes of the counterbalances are screws (named: 4; and 5 as show in the figures: #1; #2; #3; and #4) they are to each other connected by a cube with treated holes (named: 3 as show in the figures: #1; #2; #3; and #4)) that when turning the axes help to move them from side to side to find the balance center.

4. the cube with treated holes (named: 3 as show in the figures: #1; #2; #3; and #4) is connected to the vertical axis (named: 6 as show in the figures: #1; #2; #3; and #4) that also is a screw, when turning the cube (named: 3 as show in the figures: #1; #2; #3; and #4) can be raised or be lowered the cube in which it serves as support for the axes of counterbalances (named: 5 as show in the figures: #1; #2; #3; and #4).

5. The vertical axis (named: 6 as show is in the figures: #1; #2; #3; and #4) this connected with the wheel of turn of manual control (named: 9 as show in the figures: #1; #2; #3; and #5) moved by a gear motor (named: 8 as show in the figures: #1; #2; #3; and #5) the wheel also has a mechanism to absorb torque caused by the abrupt change of direction of the camera man.

6. The vertical axis of the pendulum (named: 6 as show in the figures: #1; #2; #3; and #4) this mounted on a drum of bearings (named: 10 as show in the figures: #1; #2; #3; and #5) that helps to turn the system of pendulum horizontally (named with the arrow: F as show in the figures: #1; #2; #3; and #5) by but of 360 degrees.

7. The vertical axis (named: 6 as show in the figures: #1; #2; #3; and #4) in the inferior part this connected with the support of the camera (named: G3 as show in the figure: #1) that we will describe ahead.

8. The drum of bearings (named: 10 as show in the figures: #1; #2; #3; and #5) this connected by an axis (x) (named: 13 as show in the figures: #1; #2; #3; and #5) of side to side to a ring (named: 11 as show in the figures: #1; #2; #3; and #5) this axis absorbs the movements of side to side (named: G as show in the figures: #1; #2; #3; and #5).

9. The ring (named: 11 as show in the figures: #1; #2; #3; and #5) this connected by an axis (y) (named: 12 as show in the figures: #1; #2; #3; and #5) that absorbs the movements of advances towards back (named with the Arrow: H as show in the figures: #1; #2; #3; and #5) to one *U* (named: 31 as show in the figures: #1; #2; #3; and #5) that this connected to the arm of support (named: 26 as show in the figures: #1; #2; #3; and #5)

10. The arm of support (named: 26 as show in the figures: #1; #2; #3; and #5) is operated or handled by the camera man, extension can go connected to one (named: 25 as show in the figures: #1; #2; #3; and #5) that can as well serve as counterbalance or can be connected to you arm of support.

11. The arm is bend to 45 degrees (named: 29 as show in the figures: #1; #2; #3; and #5) and to 90 degrees (named: 28 as show in the figures: #1; #2; #3; and #5), to avoid the undesired contact with the stabilized parts.

12. The support for the camera is connected to the vertical axis (named: 6 as show in the figures: #1; #2; #3; and #4) that can be raised or be lowered (named with the arrow: c as show in the figures: #1; #2; #3; and #4) this connected by one (L) inverted (named: 22 as show in the figures: #1; #2; #3; and #6)

13. The mechanism to fit the size of the camera (named: 18 as show in the figures: #1; #2; #3; and #6) this connected to the (L) inverted (named: 22 as show in the figures: #1; #2; #3; and #6) by a screw (named: 15 as show in the figures: #1; #2; #3; and #6) 14. The screw (named: 15 as show in the figures: #1; #2; #3; and #6) also serves as axis for the support (named: 16 as show in the figures: #1; #2; #3; and #6) of the gear motor for the vertical movement of the camera (named: 17 as show in the figures: #1; #2; #3; and #6).

15. The gear motor (named: 17 as show in the figures: #1; #2; #3; and #6). transferee its rotation to the wheel (named: 20 as show in the figures: #1; #2; #3; and #6). de heave of the camera (named as one is with the arrow: j as show the figures: #1; #2; #3; #4; #5; and #6).

16. The wheel (named: 20 as show in the figures: #1; #2; #3; and #6). it is hanged by an axis (named: 19 as show in the figures: #1; #2; #3; and #6). As well this mounted in the box of bearings (named: 21 as show in the figures: #1; #2; #3; and #6).

17. The video camera (named: 24 as show in the figures: #1; #2; #3; and #6). it is connected by a screw (named: 23 as show in the figures: #1; #2; #3; and #6). that it fits the camera of advances back or of side to side (named as one is with the arrows: k; and L as show In the figures: #1; #2; #3; #4; #5; and #6) to a (L) (named: 22 as show in the figures: #1; #2; #3; #4; #5; and #6) that as well this connected to the wheel (named: 20 as show in the figures: #1; #2; #3; #4; #5; and #6) 18. Additionally has a remote control mechanism to you (named: 27 as show in the figures: #1; #2; #3; #4; #5; and #6) for the manual movement of horizontal and vertical position.

19. Additionally a monitor can be used attached the body of the camera man to facilitate the video shootings while the camera this in a position that makes difficult the visibility of the camera man, by example. The camera man can walk forwards while it makes a shooting of the objective that follows it. Observing by the external monitor what shots.

1. Stabilizer and support of video camera based on balance system

2. System of remote control of movement of the horizontal and vertical camera (pan and tilt). Powered by two gear motors.

3. System of a counterbalance integrated by: two axes in horizontal cross, that are screws; four weights that are nut type, that go in the ends of the axes; cubic piece join both horizontal axes with the vertical axis that also is a screw.

4. System of torque absorber of horizontal turn integrated by: a wheel; an axis; and a spring.

5. System of universal union, integrated by a drum with bearings; floating ring; and a support in the form of U.

6. Support of the mechanism is integrated by: an arm connected in an end to the support in form of U. this dubbing in vertical form upwards to 45 degrees and towards down to 90 degrees. In the other extreme it is possible to be connected to several types of extensions.

7. System of support of the camera, integrated by: vertical axis; a piece inverted L joint with an end to a vertical axis; a nut is used for adjustment of camera size; it supports the bearing box for the vertical turn; supports the camera in the form of L.

8. Vertical system turn, integrated by: adjustable support of the motor, gear motor, with a wheel gear.
